(19) United States
(12) Patent Application Publication
(10) Pub. No.: US 2015/0363877 A1
(43) Pub. Date: Dec. 17, 2015

(54) TECHNIQUES FOR ON-LINE TRADING OF FINANCIAL SECURITIES

(71) Applicant: TRADING TICKET, LLC., New York, NY (US)

(72) Inventors: Nathan A. RICHARDSON, New York, NY (US); Gaspard Aupepin De Lamothe DREUZY, New York, NY (US); Serge KREIKER, New York, NY (US)

(21) Appl. No.: 14/602,210

(22) Filed: Jan. 21, 2015

Related U.S. Application Data
(60) Provisional application No. 62/012,932, filed on Jun. 16, 2014.

(51) Int. Cl. G06Q 40/04

(52) U.S. Cl. CPC G06Q 40/04

(57) ABSTRACT

One embodiment of the present invention sets forth approaches for trading financial securities over a computer network. An execution management system launches a plurality of brokerage applications, where each brokerage application included in the plurality of brokerage applications is configured to communicate with a different brokerage account system. The execution management system receives, from a client device, a selection of a brokerage account through which to execute a trade involving a financial security. The execution management system selects a first brokerage application included in the plurality of brokerage applications that is configured to communicate with a brokerage account system associated with the brokerage account. The execution management system causes the brokerage application to log into the brokerage account.

### CROSS-REFERENCE TO RELATED APPLICATIONS

This application claims the benefit of THE United States provisional patent application titled, “TRADING FINANCIAL SECURITIES ON-LINE,” having application No. 62/012,932 and filed on Jun. 16, 2014. The subject matter of this related application is hereby incorporated herein by reference.

### BACKGROUND OF THE INVENTION

1. Field of the Invention

Embodiments of the present invention relate generally to financial trading systems and, more specifically, to techniques for on-line trading of financial securities.

2. Description of the Related Art

Typically, retail traders in financial securities, such as stocks and exchange traded funds (ETFs), gather information as to what securities to buy and sell from a variety of information sources. For example, a trader could decide to buy or sell stock in a particular company based on reading a news article in an on-line news service, a blog post, or a post to a social media site. To execute the trade, the trader, who may have on-line accounts with multiple brokerage firms, would log into the system associated with a particular brokerage account, enter an order to buy or sell the desired security, receive a quote, and then place and execute the trade order.

One drawback with the above approach is that when the trader decides to buy or sell a security based on a particular information and data source, the trader generally has to close or navigate away from the browser instance or application associated with the information and data source, open a new browser instance or application associated the brokerage account, navigate to the correct area of the brokerage account site, and then start entering the data associated with the order, such as the name of the security, type of order, quantity of shares, and so on. Not only is this process tedious for the trader, because the process takes a relatively long time, the value of the security may change, perhaps significantly, before the trade can be executed.

Another drawback with the above approach is that different brokerage accounts may present different user interfaces to the trader. For example, each brokerage account may present a different arrangement of the user interface elements, different mechanisms to navigate between pages or sections of the site, and different requirements for entering order and quote information. For example, if a trader has accounts with five different online brokerage firms, then the trader could have to learn and remember five different user interfaces to enter orders on the various systems. As a result, the trader executes trades with reduced efficiency and increased time between deciding to trade in a security and executing the trade, again leading to decreased profit or even loss. In addition, the need to learn and remember multiple user interfaces for executing trades reduces the overall quality of the user experience.

As the foregoing illustrates, what is needed in the art is improved more effective approach for trading financial securities over a computer network.

### SUMMARY OF THE INVENTION

One embodiment of the present invention sets forth a method for trading financial securities over a computer network. The method includes launching a plurality of brokerage applications, where each brokerage application included in the plurality of brokerage applications is configured to communicate with a different brokerage account system. The method further includes receiving, from a client device, a selection of a brokerage account through which to execute a trade involving a financial security. The method further includes selecting a first brokerage application included in the plurality of brokerage applications that is configured to communicate with a brokerage account system associated with the brokerage account. The method further includes causing the brokerage application to log into the brokerage account.

Other embodiments include, without limitation, a computer-readable storage medium that includes instructions that enable a processing unit to implement one or more aspects of the present invention and a computing device configured to implement one or more aspects of the present invention.

At least one advantage of the disclosed techniques is that traders execute trades on-line more quickly. With a single mouse click or gesture, the trader moves quickly from reading about a company to entering data to place an order to buy or sell a security associated with the company. As a result, the time between deciding to trade in a particular security and executing the trade is reduced. Another advantage of the disclosed techniques is that traders is that the trade order may be associated with contextual information, based on criteria derived from an article, information, or data viewed by the trader or from profile information associated with the trader. From this contextual information, the trade order ticket may be pre-populated or pre-filled with various information, including, without limitation, an identifier associated with the security, an order type, a quantity of shares. As a result, the time between deciding to trade in a particular security and executing the trade is further reduced.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a computer network, according to one embodiment of the present invention;

FIGS. 3A-3C illustrate various computer systems that are configured to implement the execution management system of FIG. 2, according to one or more embodiments of the present invention.

FIGS. 4A-4B illustrate various server devices that are configured to implement the brokerage application of FIGS. 3A-3C, according to one or more embodiments of the present invention;

FIG. 5 illustrates a graphical user interface for entering data associated with a trading ticket, according on one embodiment of the present invention; and

FIGS. 6A-6B set forth a flow diagram of method steps for trading financial securities over a computer network, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

Among other things, embodiments of the present invention are directed towards an multi-broker, multi-asset order and execution management system that allows investors, in particular retail investors, to route seamlessly trade orders to one or several selected broker-dealer destinations to trade financial securities, including, without limitation, equities, exchange-traded funds, mutual funds, options, fixed income, commodities, futures and currencies. Embodiments of the present invention also are directed towards an order management system (OMS) that generates or collects trade orders and send requests to an execution management system (EMS) and towards the EMS, itself, which handles trade order requests from the OMS by transmitting those trade orders through one or multiple brokerage applications (BAs).

### System Overview

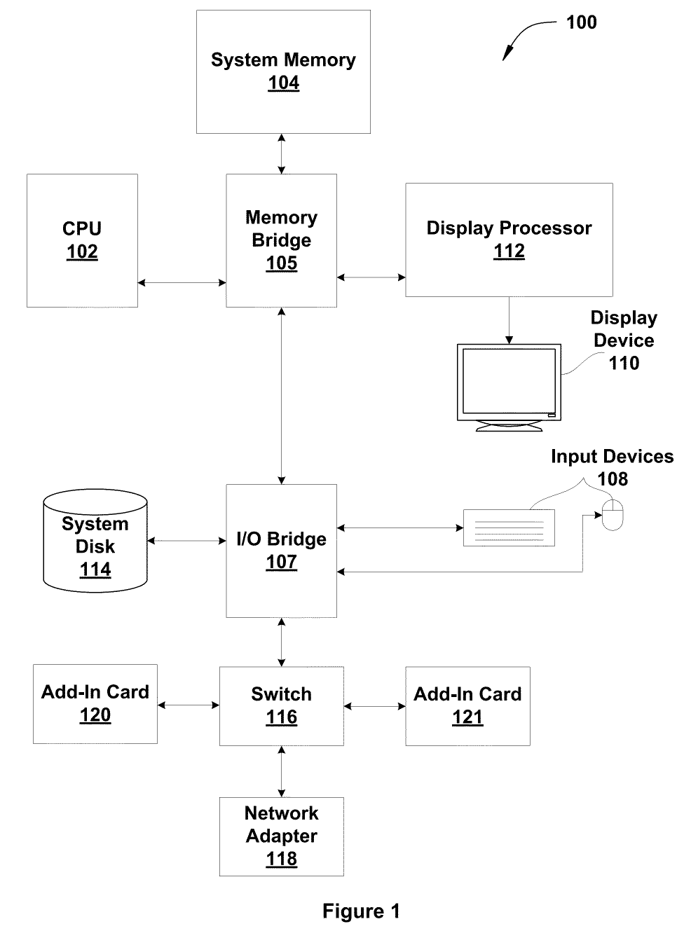

FIG. 1 is a block diagram illustrating a computer system configured to implement one or more aspects of the present invention. In various embodiments, system 100 may be a personal computer, video game console, personal digital assistant, mobile phone, mobile device or any other device suitable for implementing one or more aspects of the present invention.

As shown, system 100 includes, without limitation, a central processing unit (CPU) 102 and a system memory 104 communicating via a bus path that may include a memory bridge 105. CPU 102 includes one or more processing cores, and, in operation, CPU 102 is the master processor of system 100, controlling and coordinating operations of other system components. System memory 104 stores software applications and data for use by CPU 102. CPU 102 runs software applications and optionally an operating system. Memory bridge 105, which may be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 112 periodically delivers pixels to a display device 110 (e.g., a screen or conventional CRT, plasma, OLED, SED or LCD based monitor or television). Additionally, display processor 112 may output pixels to film recorders adapted to reproduce computer generated images on photographic film. Display processor 112 can provide display device 110 with an analog or digital signal.

A system disk 114 is also connected to I/O bridge 107 and may be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 incorporates circuitry optimized for general purpose processing. In yet another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments of the present invention, instructions and/or data representing a scene are provided to a render farm or a set of server computers, each similar to system 100, via network adapter 118 or system disk 114. The render farm generates one or more rendered images of the scene using the provided instructions and/or data. These rendered images may be stored on computer-readable media in a digital format and optionally returned to system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In an embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

CPU 102, render farm, and/or display processor 112 can employ any surface or volume rendering technique known in the art to create one or more rendered images from the provided data and instructions, including any rendering or image processing techniques known in the art.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107. Thus, persons skilled in the art will recognize that the architecture set forth in FIG. 1 in no way limits the scope of the present invention.

### Techniques for On-Line Trading of Financial Securities

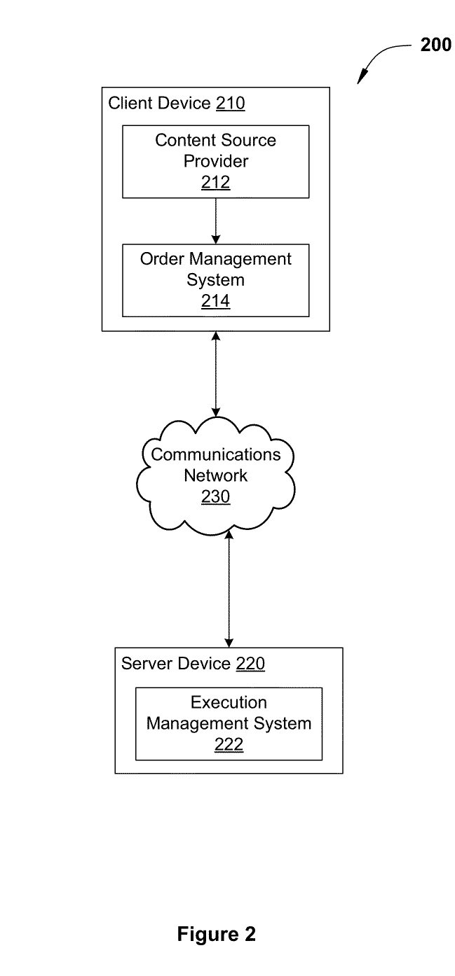

FIG. 2 illustrates a computer network 200, according to one embodiment of the present invention. As shown, the networked computer system 200 includes, without limitation, a client device 210 connected to a server device 220 via a network 230. In one embodiment, each of the client device 210 and the server device 220 may be implemented as any technically feasible variation of the computer system 100 of FIG. 1. The network 230 may be any suitable private or public network environment to enable communications among remotely located computer systems, including, without limitation, a LAN (Local Area Network) and a WAN (Wide Area Network).

The client device 210 includes, without limitation, a content source provider 212 and an order management system (OMS) 214. In various embodiments, the client device 210 may be in any technically feasible form factor, including, without limitation, a deskside computer, a laptop computer, an electronic tablet device, and a smartphone.

The content source provider 212 is any repository of information, such as web-based stock quote pages, news stories, and articles, related to publicly traded financial securities, including, without limitation equities, exchange-traded funds, mutual funds, options, fixed income, commodities, futures, and currencies. The content source provider 212 may present information in any technically feasible manner, including, without limitation, via a web browser, via a smart phone application, and via a user interface associate with a software application program. The content source provider 212 identifies securities or companies mentioned in data, news stories, and articles. For example, the content source provider 212 could highlight the name of publicly traded securities. Alternatively, or in addition, the content source provider 212 could augment or replace the name of the publicly traded security with an associated ticker symbol. If Company A, with the ticker symbol of COA, is mentioned in an article, then the content source provider 212 could replace or augment the name of Company A with the ticker symbol COA. The content source provider 212 could identify Company A by adding highlight, link, button, icon, or by otherwise identifying the name and ticker symbol of Company A.

The content source provider 212 detects a selection of a security mentioned in presented content. Continuing with the above example, the content source provider 212 could detect when a cursor is placed over the area of a display screen where the name or ticker symbol of company A appears. Alternatively, the content source provider 212 could detect when the name or ticker symbol of company A is selected via any technically feasible selection mechanism, including, without limitation, a mouse click, a selection via pen and tablet, and a finger swipe on a touch screen. Alternatively, the content source provider 212 could detect the selection of Company A via any other technically feasible approach. The content source provider 212 then transmits the name of the selected security to the OMS 214.

In one embodiment, the OMS 214 is a software application program that receives selections of securities from the content source provider 212. The OMS 214 may be implemented via any technically feasible way, including, without limitation, as an applet, a widget, web sites, a desktop or mobile applications, or as software code executing on a computer system or a server connected to a network, such as network 210. The OMS 214 may be a stand-alone application or may be a software client embedded into another environment, such as the content source provider 212. That is, the OMS 214 may be embedded into another software entity, including, without limitation, a web site, research platform, social media network, content publisher, information system, analytical tool, or in any web-based, mobile-based or desktop-based program which delivers functionality or content and allows internet communication.

When the OMS 214 receives a selection of a security from the content source provider 212, the OMS 214 generates a user interface menu representing an electronic order entry form, also referred to herein as a “trading ticket.” The trading ticket appears as a separate pop-up menu, or, alternatively, in one or more designated locations on the display screen. In some embodiments, a trading ticket may be displayed by default in one or multiple locations on the display screen without requiring any particular action by the user.

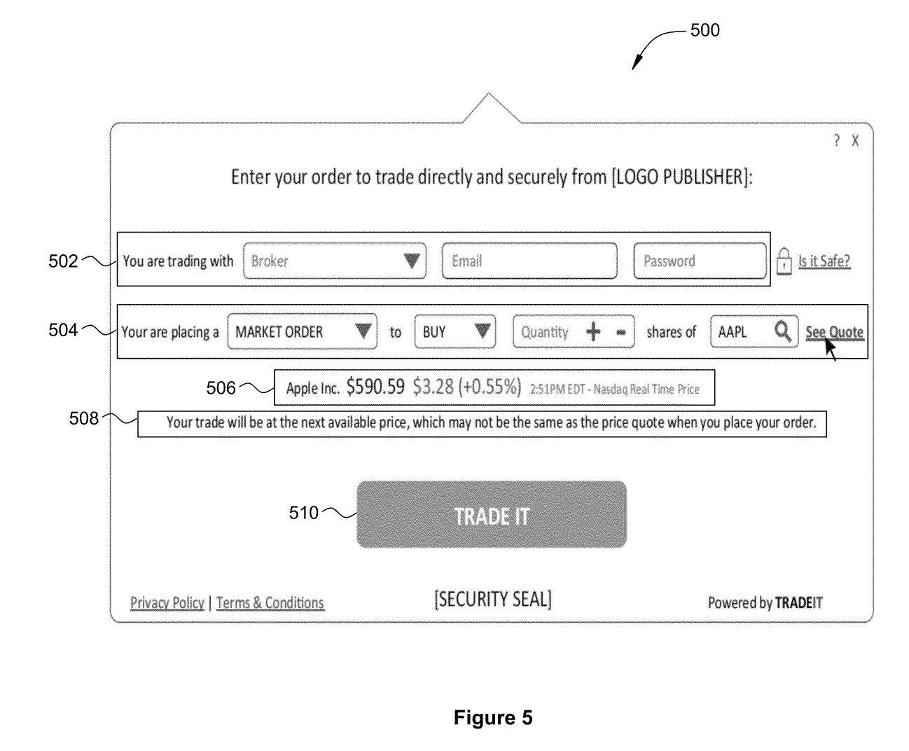

As described in greater detail below in conjunction with FIG. 5, the trading ticket includes information fields where information associated with the order or request is entered. This information includes, without limitation, one or more of a brokerage firm selection, brokerage account login credentials, an order type, a trade action, and a quantity of shares. In some embodiments, the information on the trading ticket may be entered manually. In other embodiments, one or more information fields may be pre-populated with default information that may be overridden. For example, the trading ticket could be generated for the selected security with a default quantity of 100 shares and a default trade action/trade type to buy shares at the market value. The trader would enter additional data into the remaining information fields and override the data in the pre-populated information fields, if desired, by entering different data into the pre-populated information fields.

In some embodiments, the OMS 214 may determine the set of fields and values to pre-populate based on events, signals and alerts that are triggered by data points, including, without limitation, share price, volume, time, financial news, price change, and order confirmation. Events may be triggered by any algorithm that collects and processes financial market data or trade information to generate such triggers. Data and trade information may be provided by one or several sources, such as content source provider 212, connected to the OMS 214 via the network 230. Alternatively, the OMS 214 may directly determine and generate the event triggers based upon data provided by such sources.

The OMS 214 transmits various orders and requests associated with trading tickets to an execution management system (EMS) 222 to authenticate users or accounts with one or multiple brokerage applications, review and place one or more trade orders with brokerage applications, and logout users or accounts from brokerage applications. The OMS 214 receives various responses from the EMS 222 and displays response status, such as error messages.

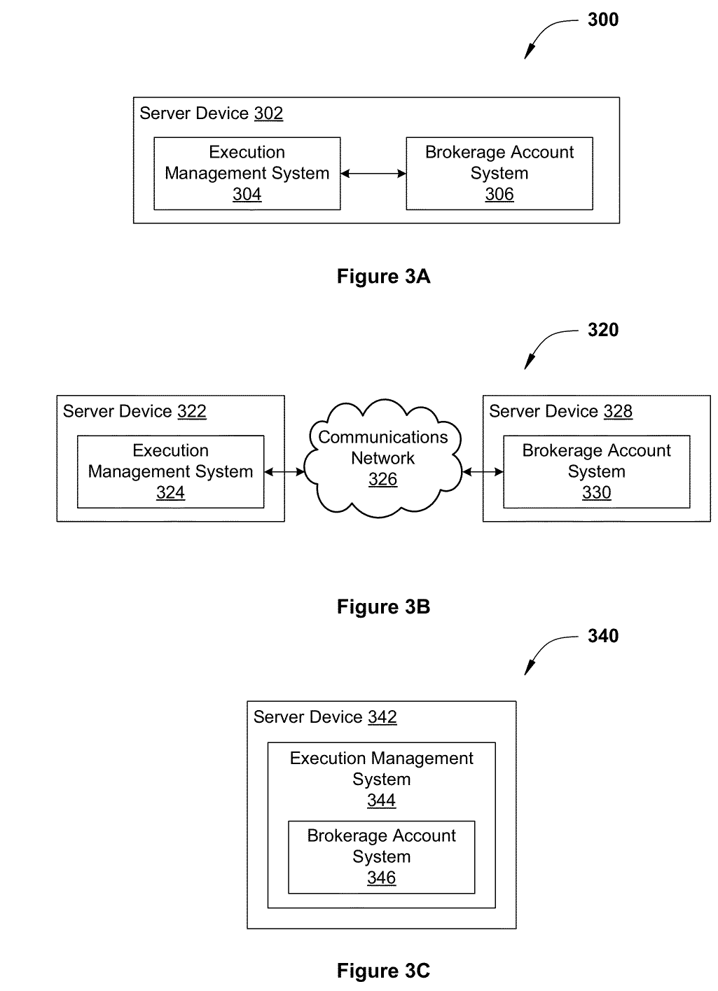

As also shown in FIG. 2, the server device 220 includes an EMS 222. The EMS 222 receives trade orders and requests from the OMS 214 and transmits those trade orders or requests to one or more brokerage applications (BAs), as described in greater detail below in conjunction with FIGS. 3A-3C. In some embodiments, the OMS 214 and the EMS 222 may execute on a single device rather than on separate client device 210 and server device 220 over the network 230.

FIGS. 3A-3C illustrate various computer systems, 300 320 and 340, that are configured to implement the execution management system of FIG. 2, according to one or more embodiments of the present invention. In one or more embodiments, in each of FIGS. 3A-3C, each of the server devices, 302, 322, 328, and 342, may be implemented as any technically feasible variation of the computer system 100 of FIG. 1. In each of FIGS. 3A-3C, each of the elements of FIGS. 3A-3C function substantially the same as their counterparts, if any, shown in FIG. 2, except as otherwise described herein.

As shown in FIG. 3A, the computer system 300 includes, without limitation, a server device 302 that, in turn, includes an EMS 304 and a brokerage application 306.

The EMS 304 receives trade orders and requests from the OMS 214. The EMS 304 is a software application program implemented via any technically feasible format, including, without limitation, a web site, a desktop application, and a mobile application. Alternatively, the EMS 304 is any software application program executing on a computer or a server connected to a network. The EMS 304 is configured to launch one or more brokerage applications, such as brokerage application 306, or otherwise cause one or more brokerage applications to execute. The EMS 304 is further configured to communicate with and interact with one or multiple brokerage applications, such as brokerage application 306.

The brokerage application 306 is typically associated with, and provided by, a particular brokerage firm or dealer. In various embodiments, the brokerage application 306 may be implemented via any technically feasible format including, without limitation, a web site, a desktop, and a mobile application. As shown in FIG. 3A, the EMS 304 launches the brokerage application 306 to execute on the same server device 302 that executes that EMS 304. Alternatively, the EMS 304 and the brokerage application 306 execute on different server devices and communicate with each other via a communications network, as further described in conjunction with FIG. 3B. Although, only one brokerage application 306 is shown, the EMS 304 typically launches multiple brokerage applications (not explicitly shown) on behalf of OMS 214, where each brokerage application is associated with a different online brokerage account. In some embodiments, each brokerage application 306 may communicate with one or more servers via an application programming interface (API) associated with a brokerage account system that hosts the online brokerage account. The API may be specified by the brokerage firm for communicating with associated online brokerage accounts. The API may be implemented via a Hypertext Transfer Protocol Secure (HTTPS) connection in order to facilitate secure communications between the brokerage application 306 and the brokerage account system associated with the online brokerage account over a network.

In addition, EMS 222 launches brokerage applications for multiple traders, where each trader is associated with one or more OMSs. For example, EMS 222 could launch a large number of brokerage applications, divided into many groups of brokerage applications. Each group of brokerage applications would be associated with a different OMS, such as OMS 214. Each trader that employs the EMS 222 to execute trades is associated with at least one OMS, such as OMS 214.

The EMS 304 communicates and interacts with the brokerage application 306 by sending commands, including, without limitation, input commands via a keyboard, mouse or touch-screen interface, programmed commands, and messages. Programmed commands include, without limitation, JavaScript commands. Messages include, without limitation, Windows Application or System Messages.

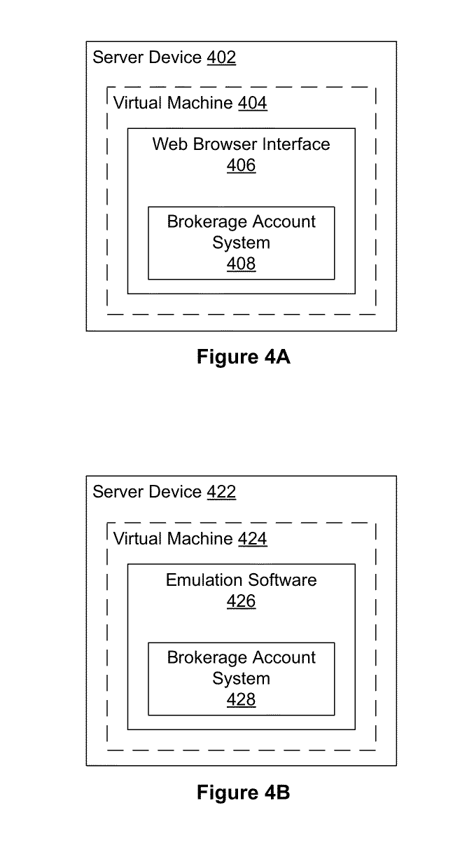

The brokerage application 306 receives and executes the input commands, programmed commands or messages received from the EMS 304. The brokerage application 306, in turn, generates corresponding information, such as quote data or order execution confirmations, and transmits the corresponding information back to the EMS 304. The EMS 304 parses and interprets the information received from the brokerage application 304 to determine whether the transmitted requests were successfully executed. In various embodiments, the brokerage application executes within a number of different compute environments, as described in greater detail in conjunction with FIGS. 4A-4B.

The EMS 304 transmits requests related to any one or more of the following: (1) launch and run one or more brokerage application 306, (2) authenticate users or accounts with a brokerage account, (3) review and place one or multiple trade orders with a brokerage firm, and (4) logout users or accounts from a brokerage account. The requests transmitted by the EMS 304 to the brokerage application 306 include related information and data such as a broker-dealer identifier, brokerage user or account credentials, trade order characteristics, and a unique session identifier.

The broker-dealer identifier may include, without limitation, a name, a number or an alpha-numeric string. The brokerage user or account credentials may include, without limitation, a username, an email address, an account number, and a password. Trade order characteristics may include, without limitation, an order type, a trade action, a security identifier, an expiration date/time, and a price. The unique session identifier may include, without limitation, a session identifier, a cookie, and a token. The unique session identifier allows the EMS 304 to map multiple requests to a given OMS 214, and provides a unique trade order identifier for the trade order to send to market.

As shown in FIG. 3B, the computer system 320 includes, without limitation, a server device 322 connected to another server device 328 via a network 326. The network 326 may be any suitable private or public network environment to enable communications among remotely located computer systems, including, without limitation, a LAN (Local Area Network) and a WAN (Wide Area Network). The server device 322 includes an EMS 324, and the server device 328 includes a brokerage application 330.

As shown in FIG. 3C, the computer system 340 includes, without limitation, a server device 342. The server device 342 includes an EMS 344 that, in turn, includes a brokerage application 346. In the configuration of FIG. 3C, the brokerage application 346 is embedded into, and executes within, the EMS 344.

FIGS. 4A-4B illustrate various server devices, 402 and 422, that are configured to implement the brokerage application of FIGS. 3A-3C, according to one or more embodiments of the present invention. In one or more embodiments, in each of FIGS. 4A-4B, each of the server devices, 402 and 422, may be implemented as any technically feasible variation of the computer system 100 of FIG. 1. In each of FIGS. 4A-4B, each of the elements of FIGS. 4A-4B function substantially the same as their counterparts, if any, shown in FIGS. 2 and 3A-3C, except as otherwise described herein.

As shown in FIG. 4A, the server device 402 optionally includes, without limitation, a virtual machine 404. In general, virtual machine 404 provides a computing environment where applications may execute in the context of a particular guest operating system that may be different from the native operating system associated with server device 402. In some embodiments, the server device 402 may execute multiple virtual machines (not explicitly shown), in addition to virtual machine 404, for any number of guest operating systems. The virtual machine 404 includes a web browser interface 406 that executes in the context of a guest operating system associated with the virtual machine 404, Alternatively, the web browser interface 406 executes in the context of the native operating system associated with the server device 402. The web browser interface 406 may include, without limitation, Google Chrome, Mozilla Firefox, Microsoft Internet Explorer, Opera, Phantomjs, or htmlunit. In some embodiments, the virtual machine 404 or, alternatively, the server device 402 may include multiple instances of web browser interfaces (not explicitly shown) in any combination. The web browser interface 406 includes a brokerage application 408 that executes within the web browser interface 406. In some embodiments, the web browser interface 406 may include multiple instances of brokerage applications (not explicitly shown) that execute within the web browser interface 406. The EMS 222 communicates with the brokerage application 408 via the web browser interface 406. In various embodiments, the EMS 222 may execute on the server device 402 or on a different server device connected to server device 402 via either a direct connection or via a network.

As shown in FIG. 4B, the server device 422 optionally includes, without limitation, a virtual machine 424. In general, virtual machine 424 provides a computing environment where applications may execute in the context of a particular guest operating system that may be different from the native operating system associated with server device 422. In some embodiments, the server device 422 may execute multiple virtual machines (not explicitly shown), in addition to virtual machine 424, for any number of guest operating systems. The virtual machine 424 includes emulation software 426 that executes in the context of a guest operating system associated with the virtual machine 424, Alternatively, the emulation software 426 executes in the context of the native operating system associated with the server device 422. The emulation software 426 may include, without limitation, a smart phone emulator and a tablet emulator. In some embodiments, the virtual machine 424 or, alternatively, the server device 422 may include multiple instances of emulation software (not explicitly shown) in any combination. The emulation software 426 includes a brokerage application 428 that executes within the emulation software 426. In some embodiments, the emulation software 426 may include multiple instances of brokerage applications (not explicitly shown) that execute within the emulation software 426. The EMS 222 communicates with the brokerage application 428 via the emulation software 426. In various embodiments, the EMS 222 may execute on the server device 422 or on a different server device connected to server device 422 via either a direct connection or via a network.

FIG. 5 illustrates a graphical user interface 500 for entering data associated with a trading ticket, according on one embodiment of the present invention. As previously described herein, the OMS 214 generates a trading ticket in response to receiving a selection of a public-traded security. The exemplary user interface 500 illustrates one possible presentation of the information fields for the entry of data related to a trading ticket. As shown, the user interface includes, without limitation, a brokerage selection window 502, an order selection window 504, a quote window 506, a status window 508, an execution button 510, and a banner window 512.

The brokerage selection window 502 includes a field for selecting one or more broker-dealer accounts to which orders and requests are routed. The brokerage selection window 502 further includes brokerage account login information such as, but not limited to, email addresses, usernames, account numbers, passwords, and answers to security questions. The OMS 214 transmits data entered into the brokerage selection window 502 to the EMS which, in turn, logs into the associated brokerage account. The EMS may log off of the brokerage account in response to an explicit request received from the OMS 214 or in response to one or more triggers, such as time, trade order submission, or trade order execution.

The order selection window 504 includes fields for selecting a trade type, a trade action, a quantity of shares or units, and a security identifier. The trade type includes, without limitation, a market order, a limit order, a stop market order, and a stop limit order. The trade action includes, without limitation, as buy, a sell, a sell short, and a buy to cover. Certain types or trades and securities need additional information or terms, not explicitly shown, such as “good for today” and “good until cancellation” expirations and price for limit orders. In some embodiments, one or more fields in the order selection window 504, or in other regions of the trading ticket, are pre-populated or pre-selected with default values determined by the context. Such values include, without limitation, a name or symbol of a security, a trading action, and an order type. The trading ticket may include a progress indicator that tracks and displays the level of completion of the order (not explicitly shown).

The quote window 506 displays relevant and contextual financial information and market data, including, without limitation, quote prices (such as last, bid and ask prices, trading volumes, estimated total amount of the transaction, recent news, and relevant trading ideas. Such information or data may be provided by one or several sources connected to the OMS 214 via a network. The OMS 214 may generate and display trade analytics by acting upon and processing data feeds provided by such sources.

The disclaimer window 508 displays or links to any desirable legal disclaimers customized as needed for each broker-dealer, each type of order, and each type of security. Such disclaimers preferably clarify the business and legal relationship (or lack thereof) between the EMS operator and the broker-dealers. This information may be particularly desirable in light of federal regulations and securities rules regulating activities between brokers and securities dealers.

The execution button 510 provides a single button that, when selected by a trader, causes the EMS to execute the trade indicated by the trading ticket.

The trading ticket may further include additional elements (not explicitly shown) such as instructions, descriptive text, security seals or content (such as terms of service and privacy policy) or functions (including customer support-related functions such as frequently asked questions and chat). The trading ticket may display or link to advertising and marketing elements, such as interactive banners, promotional messages, logos, brand icons or images.

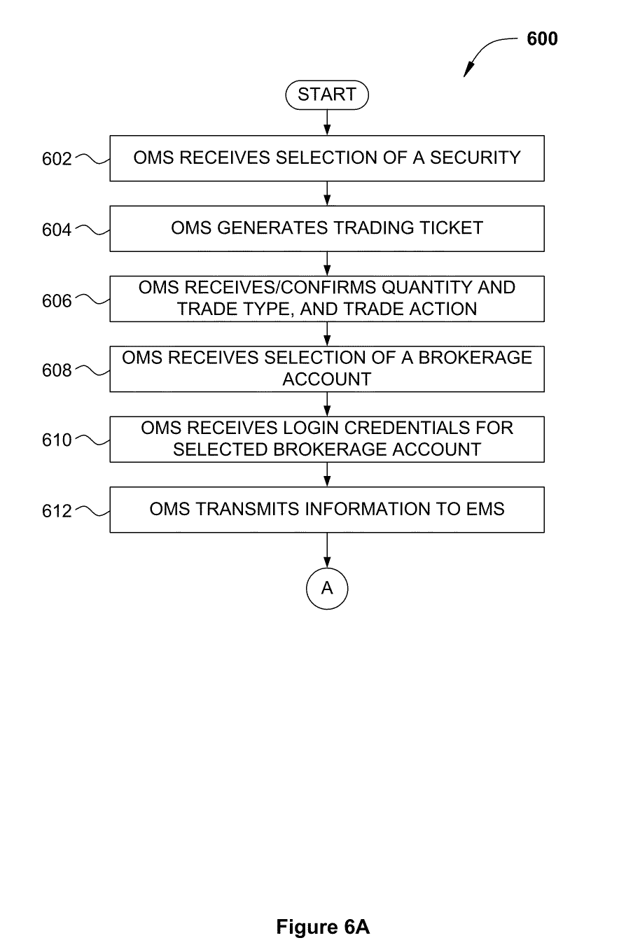

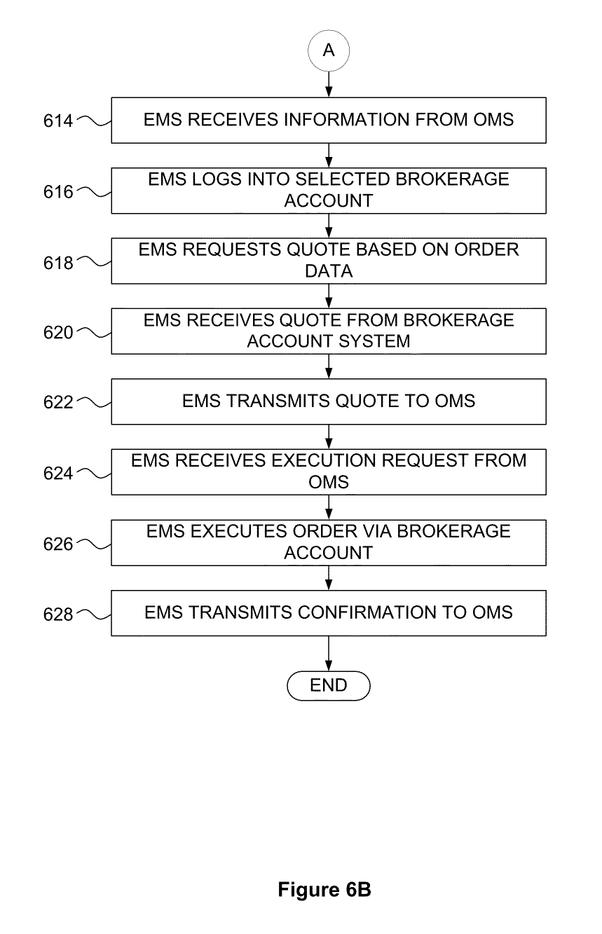

FIGS. 6A-6B set forth a flow diagram of method steps for trading financial securities over a computer network, according to one embodiment of the present invention. Although the method steps are described in conjunction with the systems of FIGS. 1-5, persons of ordinary skill in the art will understand that any system configured to perform the method steps, in any order, is within the scope of the present invention.

As shown, a method 600 begins at step 602, where an order management system (OMS) 214 receives the selection of a security from the content source provider 212. Typically, the content provider 212 transmits a security selection in response to a selection of a security identifier, such as a company name or ticker symbol, embedded within a news article, web blog, or research report. The OMS 214 receives the selection in response to a trader selecting the security identifier via the content source provider 212. At step 604, the OMS 214 generates a trading ticket corresponding to the selected security identifier, where the OMS 214 pre-populates a security information field with the security name, ticker symbol, or other identifier corresponding to the selected security. The trading ticket includes other information fields, such as quantity, trade type, and trade action, which are filled out by the trader, so that the trader may execute a trade involving the selected security. In addition to the security information fields, the OMS 214 may pre-populate other fields with default or previously selected values. For example, the OMS 214 may pre-populate a quantity field with 100 shares and a trade type field with market order.

At step 606, the OMS 214 receives a quantity, trade type, and trade action. For any pre-populated information fields, the OMS 214 confirms whether one or more information fields was overridden by the entry of a value different from the pre-populated value. At step 608, the OMS 214 receives a selection of a brokerage account via the trading ticket. At step 610, the OMS 214 receives login credentials for the selected brokerage account via the trading ticket. At step 612, the OMS 214 transmits the received information, including one or more of the brokerage selection, login credentials, security identifier, quantity, trade type, and trade action to an execution management system (EMS) 222.

At step 614, the EMS 222 receives the above information from the OMS 214. At step 616, the EMS 222 logs into the selected brokerage account system via a brokerage application using the received login credentials. The EMS 222 communicates with multiple brokerage applications, where each brokerage application is configured to communicate with a particular online brokerage account system. Through these brokerage applications, the EMS 222 may request quotes and execute trades based on the trading ticket information received the OMS 214 regardless of which brokerage is selected by the trader. In other words, the EMS 222 selects a brokerage application configured to communicate with the brokerage account system corresponding to the brokerage specified by the OMS 214. The EMS 222 then logs into the account specified by the login credentials via the selected brokerage application.

At step 618, the EMS 222 requests a quote via the brokerage application based on the received order data. At step 620, the EMS 222 receives a quote from the selected brokerage application. At step 622, the EMS 222 transmits the quote to the OMS 214. At step 624, the EMS 222 receives an execution request from the OMS 214. At step 626, the EMS 222 executes the order via the brokerage application associated with the selected brokerage account. At step, 628, the EMS 222 transmits a confirmation to the OMS 214. The method 600 then terminates.

In sum, financial securities are traded over a computer network via an order management system that generates a trading ticket in response to a trader selecting an name, ticker symbol, or other identifier from an information source, such as a news story, article, or social media post. The order management system pre-populates the trading ticket with the security identifier. The order management system receives additional information via the trading ticket, including a selection of broker-dealer, login credentials, quantity, trade type, trade action, and other order information. The order management system transmits the information to an execution management system that logs into a brokerage account system via a brokerage application associated with the selected broker-dealer and requests a quote for the order specified by the trading ticket. When received, the execution management system transmits the quote to the order management system. Upon receiving an execution request from the order management system, the execution management system causes the brokerage application to execute the order and transmits an order confirmation to the order management system.

One advantage of the disclosed techniques is that traders execute trades on-line more quickly. With a single mouse click or gesture, the trader moves quickly from reading about a company to entering data to place an order to buy or sell a security associated with the company. As a result, the time between deciding to trade in a particular security and executing the trade is reduced, thereby reducing the risk that the value of the security changes before the trade is executed. Another advantage of the disclosed techniques is that the trader is presented with the same user interface regardless of which brokerage account the trader selects to execute the trade. As a result, the time from decision to order execution is further reduced and the trader's on-line experience is enhanced.

Another advantage of the disclosed techniques is that traders is that the trade order may be associated with contextual information, based on criteria derived from an article, information, or data viewed by the trader or from profile information associated with the trader. From this contextual information, the trade order ticket may be pre-populated or pre-filled with various information, including, without limitation, an identifier associated with the security, an order type, a quantity of shares. As a result, the time between deciding to trade in a particular security and executing the trade is further reduced.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for trading financial securities over a computer network, the method comprising:
launching a plurality of brokerage applications, wherein each brokerage application included in the plurality of brokerage applications is configured to communicate with a different brokerage account system;
receiving, from a client device, a selection of a brokerage account through which to execute a trade involving a financial security;
selecting a first brokerage application included in the plurality of brokerage applications that is configured to communicate with a brokerage account system associated with the brokerage account; and
causing the brokerage application to log into the brokerage account.

2. The method of claim 1, wherein causing the brokerage application to log into the brokerage account comprises:
receiving login credentials from the client device; and
transmitting the login credentials to the first brokerage application.

3. The method of claim 1, further comprising:
receiving, from the client device, order information associated with the trade; and
transmitting the order information to the brokerage application.

4. The method of claim 1, further comprising:
receiving, from the brokerage application, a quote related to the order information; and
transmitting the quote to the client device.

5. The method of claim 1, further comprising receiving a selection of a security identifier from a content source provider.

6. The method of claim 5, further comprising generating a trading ticket that includes a plurality of information fields associated with the trade.

7. The method of claim 1, further comprising pre-populating a first information field in a plurality of information fields with the security identifier.

8. A computer-readable storage medium including instructions that, when executed by a processing unit, cause the processing unit to perform an operation for trading financial securities over a computer network, the operation comprising:
launching a plurality of brokerage applications, wherein each brokerage application included in the plurality of brokerage applications is configured to communicate with a different brokerage account system;
receiving, from a client device, a selection of a brokerage account through which to execute a trade involving a financial security;
selecting a first brokerage application included in the plurality of brokerage applications that is configured to communicate with a brokerage account system associated with the brokerage account; and
causing the brokerage application to log into the brokerage account.

9. The computer-readable storage medium of claim 8, wherein causing the brokerage application to log into the brokerage account comprises:
receiving login credentials from the client device; and
transmitting the login credentials to the first brokerage application.

10. The computer-readable storage medium of claim 8, further comprising:
receiving, from the client device, order information associated with the trade; and
transmitting the order information to the brokerage application.

11. The computer-readable storage medium of claim 8, further comprising:
receiving, from the brokerage application, a quote related to the order information; and
transmitting the quote to the client device.

12. The computer-readable storage medium of claim 8, wherein launching a plurality of brokerage applications comprises launching the first brokerage application within a web browser interface configured to execute on a first server device.

13. The computer-readable storage medium of claim 8, wherein launching a plurality of brokerage applications comprises launching the first brokerage application within a device emulation software application configured to execute on a first server device.

14. The computer-readable storage medium of claim 8, wherein launching a plurality of brokerage applications comprises launching the first brokerage application within a virtual machine configured to execute on a first server device.

15. A computer system for trading financial securities over a computer network, comprising:
an order management system configured to:
transmit a selection of a brokerage account through which to execute a trade involving a financial security; and
an execution management system configured to:
launch a plurality of brokerage applications, wherein each brokerage application included in the plurality of brokerage applications is configured to communicate with a different brokerage account system,
receive, from the order management system, the selection of the brokerage account,
select a first brokerage application included in the plurality of brokerage applications that is configured to communicate with a brokerage account system associated with the brokerage account, and
cause the brokerage application to log into the brokerage account.

16. The computer system of claim 15, wherein causing the brokerage application to log into the brokerage account comprises:
receiving login credentials from the client device; and
transmitting the login credentials to the first brokerage application.

17. The computer system of claim 15, wherein the order management system is further configured to transmit, to the execution management system, order information associated with the trade, and the execution management system is further configured to transmit the order information to the brokerage application.

18. The computer system of claim 15, the execution management system is further configured to:
receive, from the brokerage application, a quote related to the order information; and
transmit the quote to the order management system.

19. The computer system of claim 15, wherein the order management system is further configured to receive a selection of a security identifier from a content source provider.

20. The computer system of claim 19, wherein the order management system is further configured to:
generate a trading ticket that includes a plurality of information fields associated with the trade; and
pre-populate a first information field in a plurality of information fields with the security identifier.
